(19) United States
(12) Patent Application Publication
(10) Pub. No.: US 2026/0097941 A1
(43) Pub. Date: Apr. 9, 2026

(54) CARGO HANDLING SYSTEM AND INDUSTRIAL VEHICLE FOR PERFORMING CARGO HANDLING OPERATION

(71) Applicant: KABUSHIKI KAISHA TOYOTA JIDOSHOKKI, Kariya-shi (JP)

(72) Inventor: Hirokazu KISHIDA, Kariya-shi (JP)

(73) Assignee: KABUSHIKI KAISHA TOYOTA JIDOSHOKKI, Kariya-shi (JP)

(21) Appl. No.: 18/909,321

(22) Filed: Oct. 8, 2024

(30) Foreign Application Priority Data
Oct. 12, 2023 (JP) 2023-176917

(51) Int. Cl. B66F 9/075; G06V 20/58; H04N 7/18

(52) U.S. Cl. CPC B66F 9/0755; G06V 20/58; H04N 7/183

(57) ABSTRACT

A cargo handling system in which an industrial vehicle performs cargo handling operation includes the industrial vehicle, a work site where the industrial vehicle performs cargo handling operation, a monitoring unit configured to monitor a state at a transition position where one process transitions to another process in the cargo handling operation, and a determination unit configured to determine whether a subsequent process is performable based on information acquired by the monitoring unit.

### CROSS-REFERENCE TO RELATED APPLICATION

This application claims priority to Japanese Patent Application No. 2023-176917 filed on Aug. 12, 2023, the entire disclosure of which is incorporated herein by reference.

The present disclosure relates to a cargo handling system.

### BACKGROUND ART

Japanese Patent Application Publication No. 2021-195215 discloses an example of a conventional cargo handling system. In this conventional cargo handling system, an industrial vehicle such as a forklift truck performs cargo handling operation to a transport vehicle. The cargo handling system includes a device, as a ground device, that measures a distance. The cargo handling system measures a distance to a pallet on a loading platform, and transmits instructions related to cargo handling to the industrial vehicle based on the distance information.

In the conventional cargo handling system described above, when one process has been performed and a subsequent process is to be performed during the cargo handling operation, there may be a need for a determination on whether or not the subsequent process can be performed. An operator on-site has to check such transition of processes in the cargo handling operation. Therefore, there has been a demand for manpower-saving in the cargo handling system.

The present disclosure has been made to solve the above-mentioned problems, and is directed to providing a cargo handling system that achieves man-power saving.

### SUMMARY

In accordance with a present disclosure, there is provided a cargo handling system in which an industrial vehicle performs cargo handling operation, the cargo handling system including the industrial vehicle, a work site where the industrial vehicle performs cargo handling operation, a monitoring unit configured to monitor a state at a transition position where one process transitions to another process in the cargo handling operation, and a determination unit configured to determine whether a subsequent process is performable based on information acquired by the monitoring unit.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a side view illustrating an example of an industrial vehicle of a cargo handling system according to the present disclosure;

FIG. 2 is a plan view illustrating an example of the cargo handling system;

FIG. 3 is a front view illustrating the example of the cargo handling system;

FIGS. 4A and 4B each are a schematic diagram illustrating a configuration of a monitoring unit of an industrial vehicle.

FIG. 5 is a block diagram illustrating a configuration of the cargo handling system;

FIG. 6 is an image showing a state in which a determination unit makes a determination using artificial intelligence;

FIG. 7 is a flowchart showing an example of processing of the cargo handling system;

FIG. 8 is a flowchart showing the example of processing of the cargo handling system;

FIG. 9 is a flowchart showing the example of processing of the cargo handling system;

FIG. 10 is a flowchart showing the example of processing of the cargo handling system;

FIG. 11 is a flowchart showing an example of processing of the cargo handling system;

FIG. 12 is a flowchart showing the example of processing of the cargo handling system; and

FIG. 13 is a flowchart showing the example of processing of the cargo handling system;

FIG. 14 is a flowchart showing an example of processing of the cargo handling system;

FIG. 15 is a flowchart showing the example of processing of the cargo handling system;

FIG. 16 is a flowchart showing the example of processing of the cargo handling system; and

FIGS. 17A, 17B and 17C are views illustrating a cargo handling system according to a modified example.

### DETAILED DESCRIPTION OF THE EMBODIMENTS

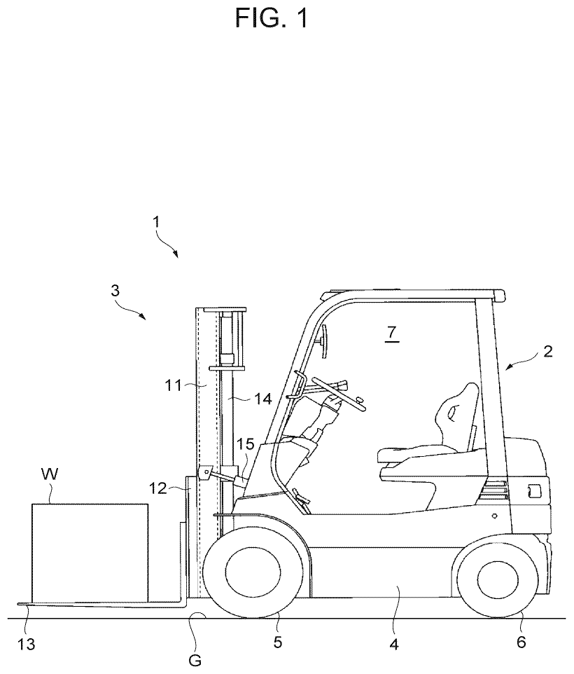

FIG. 1 is a side view illustrating an example of an industrial vehicle 1 according to the present disclosure. The industrial vehicle 1 is a vehicle that performs loading and unloading of cargos W from a transport vehicle. A forklift truck is used as the industrial vehicle 1. The forklift truck is not limited to any particular type, and may be a reach type or a counter type. As illustrated in FIG. 1, the industrial vehicle 1 includes a travelling device 2, a cargo handling device 3 that is disposed in front of the travelling device 2 and has forks 13, and a travelling control unit that controls travelling of the industrial vehicle 1.

The travelling device 2 includes a vehicle body 4, front wheels 5 which are a pair of drive wheels disposed at the front of the vehicle body 4, and rear wheels 6 which are a pair of steered wheels disposed at the rear of the vehicle body 4. The vehicle body 4 includes an operator's cab 7 formed of a frame including a head guard. A lift operation lever used to operate a lift cylinder 14, a tilt operation lever used to operate a tilt cylinder 15, a steering wheel for steering the industrial vehicle 1, and the like, are provided in the operator's cab 7. In addition, the travelling device 2 includes a travelling motor that rotates the front wheels 5, and a steering motor that steers the rear wheels 6 by rotating a steering shaft of the industrial vehicle 1. The travelling device 2 causes the travelling motor to rotate the front wheels 5, and the steering motor to steer the rear wheels 6, thereby causing the industrial vehicle 1 to travel.

The cargo handling device 3 includes a mast 11 attached to the front of the vehicle body 4, a pair of forks 13 attached to the mast 11 via a lift bracket 12 and holding a cargo W, the lift cylinder 14 for moving the forks 13 up and down, and the tilt cylinder 15 for tilting the mast 11. The forks 13 are attached to the lift bracket 12 so as to protrude forward from the lift bracket 12.

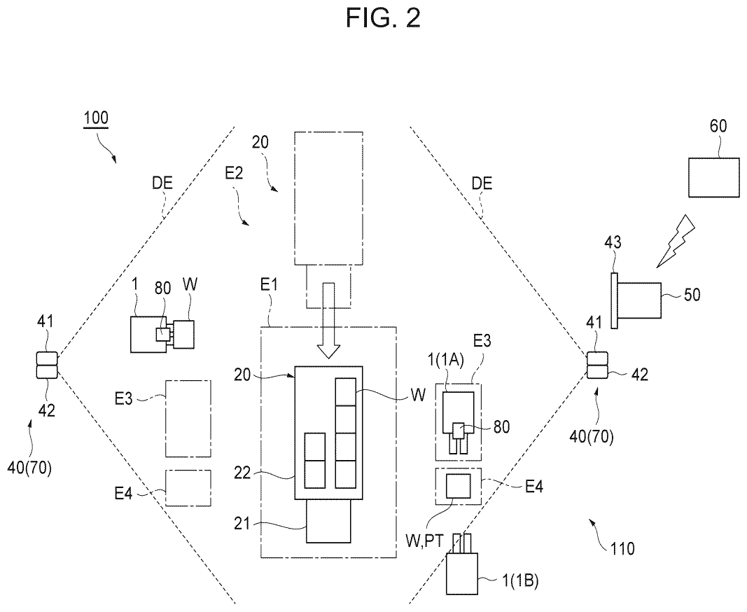

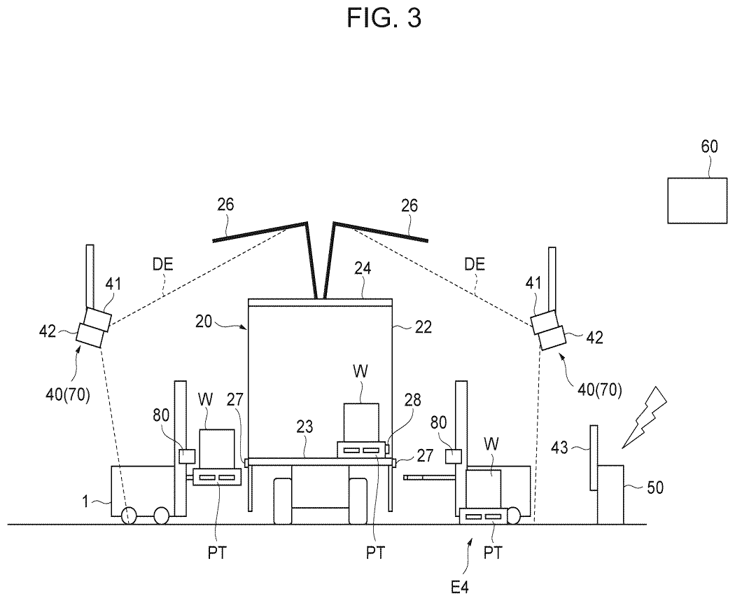

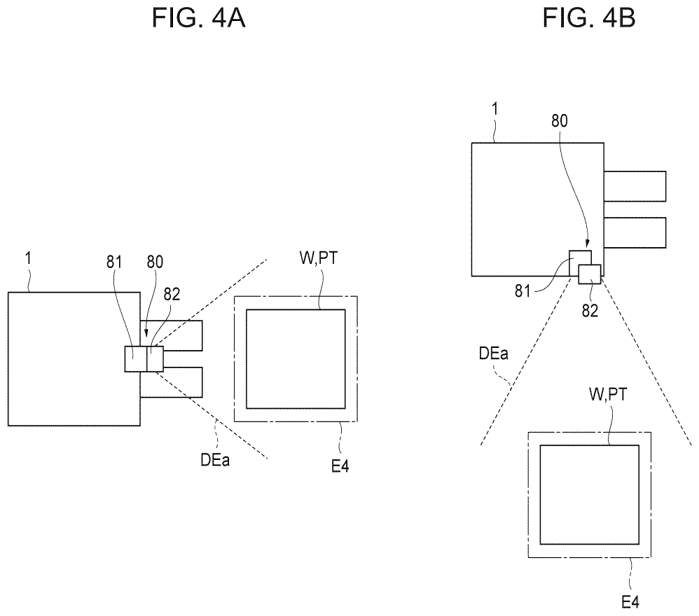

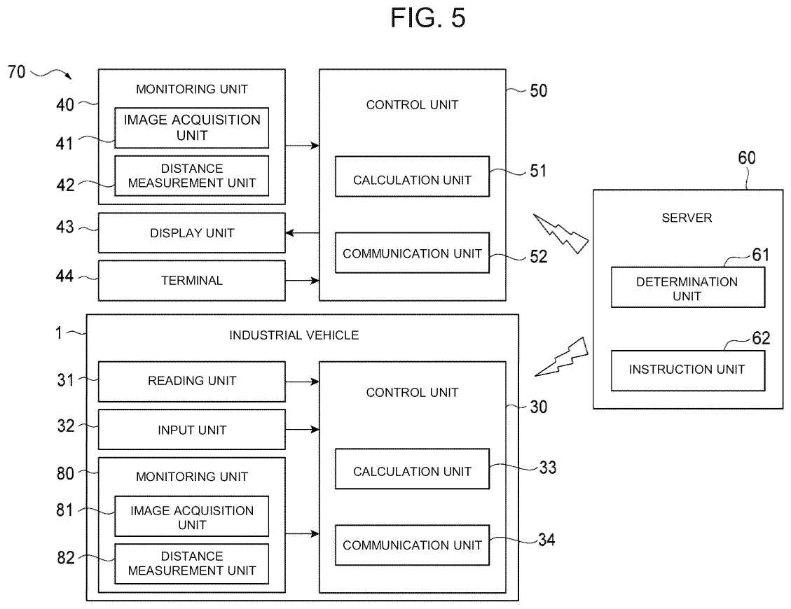

Next, the configuration of the cargo handling system 100 will be described with reference to FIGS. 2 to 5. FIG. 2 is a plan view of the cargo handling system 100. FIG. 3 is a front view of the cargo handling system 100. FIG. 4 is a schematic view of the industrial vehicle 1. FIG. 5 is a block diagram of the cargo handling system 100. As illustrated in FIGS. 2 and 3, the cargo handling system 100 includes the above-mentioned industrial vehicle 1, a transport vehicle 20, a work site 110, a ground equipment 70, and a server 60. The cargo handling system 100 is a system in which the industrial vehicle 1 performs cargo handling operation to the transport vehicle 20.

As illustrated in FIG. 5, the industrial vehicle 1 includes a control unit 30, a reading unit 31, an input unit 32, and a monitoring unit 80. The control unit 30 is a device that controls the entire industrial vehicle 1. The control unit 30 includes a CPU, a RAM, a ROM, input/output interfaces, and the like. The control unit 30 includes a calculation unit 33 that performs various types of calculations, and a communication unit 34 that performs communication. The communication unit 34 communicates with the ground equipment 70 and the server 60. The reading unit 31 is a device capable of reading various types of information. The reading unit 31 reads identification information from identification information providing units 27, 28 which will be described later. The reading unit 31 may include an image acquisition unit such as a camera, an RFID reader that reads an RFID tag, and the like. A position of the reading unit 31 in the industrial vehicle 1 is not limited to any particular position as long as the identification information providing units 27, 28 can be read by the reading unit 31. The input unit 32 is a device on which various types of information can be input to the industrial vehicle 1. The input unit 32 includes various types of switches, a touch panel, and the like. The monitoring unit 80 will be described in detail later.

As illustrated in FIG. 2, the transport vehicle 20 includes a travel unit 21 and a loading platform 22 on which cargos W are loaded. In the present embodiment, a truck is used as the transport vehicle 20. As illustrated in FIG. 3, the loading platform 22 includes a floor portion 23, a ceiling portion 24, and a pair of wings 26. The pair of wings 26 opens and closes side portions of the loading platform 22. The wings 26 open and close using the ceiling portion 24 as a hinge. The pallet PT on which the cargos W are placed is loaded on the floor portion 23 of the loading platform 22.

The identification information providing unit 27 that provides identification information for identifying the transport vehicle 20 is provided in the loading platform 22. The identification information providing unit 28 that provides identification information for identifying the cargos W on each pallet PT is provided in the corresponding pallet PT. For example, a medium that can be read based on an image may be used as the identification information providing units 27, 28. For example, the identification information providing units 27, 28 each may be a QR code (registered trademark), a bar code, or the like. Alternatively, the identification information providing units 27, 28 may be a medium that can be read by a reading device. For example, an RFID tag or the like may be used as the medium that can be read by the reading device. The identification information providing units 27, 28 are read by the reading unit 31 (see FIG. 5) provided on the industrial vehicle 1.

As illustrated in FIG. 2, the work site 110 has a stopping area E1, a waiting place E2, a home position E3, and a transition position E4. The stopping area E1 is an area where the transport vehicle 20 stops. The industrial vehicle 1 performs unloading of the cargo W loaded on the loading platform 22 of the transport vehicle 20 stopped in the stopping area E1. The waiting place E2 is an area where the transport vehicle 20 waits. At the waiting place E2, the transport vehicle 20 waits until the stopping area E1 becomes available for stopping. The home position E3 is an area where the industrial vehicle 1 waits while the industrial vehicle 1 is not performing cargo handling operation.

The transition position E4 is a position where one process transitions to another process in the cargo handling operation. A subsequent process is performed for the pallet PT and the cargo W, which are placed at the transition position E4 in the previous process. Here, an industrial vehicle 1A performs an unloading process in which the pallet PT and the cargo W are unloaded from the transport vehicle 20, and then placed at the transition position E4. Another industrial vehicle 1B performs a transporting process in which the pallet PT and the cargo W placed at the transition position E4 are lifted and transported from the transition position E4 to a dispatching position. The industrial vehicle 1B, which performs the transporting process, does not have to be a forklift truck, and may be another type of a vehicle such as an AMR. Furthermore, the industrial vehicle 1A may place the pallet PT directly at the transition position E4, or may hand over the pallet PT and the cargo W to the industrial vehicle 1B, such as the AMR, waiting at the transition position E4. In this way, the unloading process transitions to the transporting process at the transition position E4. In addition, once the industrial vehicle 1A, which performs the unloading process, places the pallet PT and the cargo W at the transition position E4, the industrial vehicle 1A may return to unloading of another pallet PT and another cargo W, or may wait until the transition position E4 becomes available. In a state where there are the pallet PT and cargo W previously placed at the transition position E4, the industrial vehicle 1A, which performs the unloading process, waits to perform the unloading process at the transition position E4 until the pallet PT and cargo W previously placed are transported. In a state where the pallet PT and the cargo W are placed at the transition position E4, the industrial vehicle 1B, which performs the transporting process, lifts up and transports the pallet PT and the cargo W. In a state where the pallet PT and the cargo W are not placed at the transition position E4, the industrial vehicle 1B, which performs the transporting process, waits until the pallet PT and the cargo W are placed.

The ground equipment 70 is a device provided at a position different from the industrial vehicle 1 and the transport vehicle 20 in the work site 110. That is, the ground equipment 70 is not mounted on the industrial vehicle 1 or the transport vehicle 20, but is provided as a device on a facility side. The ground equipment 70 includes monitoring units 40 and a control unit 50.

The control unit 50 is a device that controls the entire ground equipment 70. The control unit 50 includes a CPU, a RAM, a ROM, input/output interfaces, and the like. The control unit 50 may be disposed at any position in the work site 110 that does not disturb cargo handling operation. As illustrated in FIG. 5, the control unit 50 includes a calculation unit 51 that performs various types of calculations, and a communication unit 52 that performs communication. The communication unit 52 can communicate with the industrial vehicle 1 and the server 60.

As illustrated in FIG. 5, the ground equipment 70 includes a display unit 43 and a terminal 44. The display unit 43 is a device that receives display information from the control unit 50 to show it in the work site 110. The display unit 43 may be a monitor, a touch panel, or the like. The display unit 43 only needs to be provided at the position of the control unit 50 (see FIGS. 2 and 3), or only needs to be provided at any position in the work site 110. The display unit 43 displays information such as whether cargo handling operation can be started, temporary halt of the cargo handling operation, or ending of the cargo handling operation. The terminal 44 is a device on which an operator can input information in the work site 110. The terminal 44 transmits input information to the control unit 50. The terminal 44 may be a dedicated operation terminal, a tablet, a smartphone, or the like. The terminal 44 can accept button operations to indicate an intention to start automated operation or an intention to resume automated operation.

Next, the monitoring units 40 of the ground equipment 70 and the monitoring unit 80 of the industrial vehicle 1 will be described. The monitoring units 40 of the ground equipment 70 monitor at least one of the loading platform 22 of the transport vehicle 20 stopped in the stopping area E1 and a surrounding area of the loading platform 22 stopped in the stopping area E1. The monitoring units 40 each includes an image acquisition unit 41 that acquires an image, and a distance measurement unit 42 that measures the distance to a target object. The monitoring unit 40 has a monitoring area DE. The monitoring area DE includes the stopping area E1, the waiting place E2 and the home position E3. In the present embodiment, the cargo handling system 100 has a pair of monitoring units 40. One of the monitoring units 40 monitors one side of the transport vehicle 20. The other of the monitoring units 40 monitors the other side of the transport vehicle 20. Although positions of the monitoring units 40 are not limited to any particular positions, the monitoring units 40 are disposed at positions spaced above the ground so as to monitor the sides of the transport vehicle 20 entirely and the surroundings of the transport vehicle 20, as illustrated in FIG. 3. The image acquisition unit 41 is a device that acquires an image within the monitoring area DE. The image acquisition unit 41 is, for example, a camera. The distance measurement unit 42 is a device that measures a distance to the target object existing in the monitoring area DE. The distance measurement unit 42 is, for example, a 3D LIDAR, or the like.

Furthermore, the monitoring unit 40 of the ground equipment 70 may monitor a state at the transition position E4. The monitoring unit 40 may monitor whether or not the pallet PT and the cargo W are placed at the transition position E4. The monitoring unit 40 may also monitor whether or not an obstacle other than the pallet PT and the cargo W is present at the transition position E4. Examples of the obstacle, a target to be monitored, include a person such as an operator and an object other than the pallet PT and the cargo W.

As illustrated in FIGS. 4 and 5, the monitoring unit 80 of the industrial vehicle 1 includes an image acquisition unit 81 that acquires an image, and a distance measurement unit 82 that measures a distance to the target object. The monitoring unit 80 has a monitoring area DEa. As illustrated in FIG. 4A, the monitoring unit 80 may be disposed in a front of the industrial vehicle 1. In this case, the monitoring area DEa is set in front of the industrial vehicle 1. As illustrated in FIG. 4B, the monitoring unit 80 may be disposed on a lateral surface side of the industrial vehicle 1. In this case, the monitoring area DEa is set to a lateral direction of the industrial vehicle 1. The configuration of the monitoring unit 80 is not limited to the configuration illustrated in FIGS. 4A and 4B. It is noted that the image acquisition unit 81 and the distance measurement unit 82 do not have to be provided both, and one of the image acquisition unit 81 and the distance measurement unit 82 may be omitted. In addition, positions of the image acquisition unit 81 and the distance measurement unit 82 are not particularly limited to the configuration in FIG. 4. In addition, the image acquisition unit 81 and the distance measurement unit 82 may face different directions. For example, the distance measurement unit 82 may be provided at the rear of the industrial vehicle 1 to monitor an obstacle behind the industrial vehicle 1. The image acquisition unit 81 and the distance measurement unit 82 may be used selectively depending on an object to be monitored. For example, the image acquisition unit 81 may detect the pallet PT, and the distance measurement unit 82 may detect an obstacle such as a person.

The monitoring unit 80 of the industrial vehicle 1 may monitor the state at the transition position E4. The monitoring unit 80 may monitor whether or not the pallet PT and the cargo W are placed at the transition position E4. The monitoring unit 80 may also monitor whether or not an obstacle other than the pallet PT and the cargo W is present at the transition position E4. As illustrated in FIG. 4A, when the monitoring unit 80 is provided in the front of the industrial vehicle 1, the monitoring unit 80 can monitor the transition position E4 in front. As illustrated in FIG. 4B, when the monitoring unit 80 is provided on the lateral surface side of the industrial vehicle 1, the monitoring unit 80 can monitor the transition position E4 in the lateral direction of the industrial vehicle 1.

The transition position E4 may be monitored by both of the monitoring unit 40 and the monitoring unit 80, or by one of the monitoring unit 40 and the monitoring unit 80. When the monitoring unit 40 of the ground equipment 70 monitors the transition position E4, the monitoring unit 80 of the industrial vehicle 1 may be omitted.

The server 60 performs various types of information processing in the cargo handling system 100 and accumulates various types of information. The server 60 may be provided in the work site 110 or may be provided outside the work site 110. The server 60 may be a cloud server, or the like. As illustrated in FIG. 5, the server 60 includes a determination unit 61 and an instruction unit 62. The determination unit 61 determines a state of the loading platform 22 and a state of the surrounding area of the loading platform 22 based on the information acquired by the monitoring units 40. The determination unit 61 makes the determination using artificial intelligence. The artificial intelligence is trained based on data in which past monitoring information from the monitoring unit 40 is linked with a state corresponding to the past monitoring information. For example, the artificial intelligence is trained from image data acquired by the monitoring units 40. The instruction unit 62 transmit an instruction to the industrial vehicle 1 based on a result of determination result by the determination unit 61. There is no particular limitation as to where the determination unit 61 and the instruction unit 62 are provided in the cargo handling system 100, and the determination unit 61 and the instruction unit 62 may be provided in the control unit 50, or in the ground equipment 70 other than the control unit 50.

The determination unit 61 makes a determination related to the cargo handling operation. Specifically, the determination unit 61 determines whether or not the transport vehicle 20 is present in the stopping area E1 and the waiting place E2. The determination unit 61 determines the position of the transport vehicle 20 in each of the areas E1, E2. The determination unit 61 determines whether the wings 26 of the transport vehicle 20 are open or closed. The determination unit 61 determines whether or not there is an obstacle on the loading platform 22. The determination unit 61 determines a height of the loading platform of the transport vehicle 20. In the following description, the determination related to a state of the transport vehicle 20 may be referred to as “determination of the state of the transport vehicle 20.” In addition, the determination unit 61 determines whether or not an obstacle (a person such as an operator) is present in the surrounding area of the transport vehicle 20. For these determination contents, the determination unit 61 may make a determination using both of the image data and the distance data, but may be configured to make a determination only from the image data using artificial intelligence or the like. Based on these results of determination, the instruction unit 62 issues an instruction for the cargo handling operation to the industrial vehicle 1. The instruction unit 62 issues an instruction regarding positions where cargos are placed, an order of unloading, the number of cargos, and the like. Furthermore, when the determination unit 61 determines that a person is present in the surrounding area of the loading platform 22, the instruction unit 62 transmits a stop instruction to the industrial vehicle 1. The determination unit 61 also determines information relating to a state of the cargo handling operation. For example, the determination unit 61 determines whether or not the cargo handling operation can be started and whether or not the cargo handling operation has been completed.

The determination unit 61 may determine a destination based on the identification information of the pallets PT. The instruction unit 62 issues an instruction for a place where the cargos W are to be placed. The determination unit 61 determines a shape of the pallet PT based on sizes of pallet holes included in the identification information, and the instruction unit 62 issues an instruction indicating an optimal distance between the forks. The server 60 may manage information regarding which and how many cargos W are loaded on which transport vehicle 20 based on the identification information of the transport vehicle 20 and the identification information of the pallets PT. The determination unit 61 may determine which transport vehicle 20 is stopped in the stopping area E1 based on the identification information of the transport vehicle 20, and identify the cargos W from the information managed by the server. Then, the instruction unit 62 issues an instruction for an unloading destination to causes the industrial vehicle 1 to perform the automated operation. The instruction unit 62 also issues an instruction relating to a designated pallet, a location of loading, a loading order, and the number of pallets to cause the industrial vehicle 1 to perform the automated operation.

The determination unit 61 may determine whether or not the subsequent process can be performed based on the information acquired by the monitoring units 40, 80. The determination unit 61 determines that the subsequent process can be performed based on arrival of the target object at the transition position E4. When the pallet PT as the target object arrives at the transition position E4, the determination unit 61 determines that the industrial vehicle 1B, which performs the transporting process, can perform the transporting process which is performed subsequently to the unloading process. At this time, the instruction unit 62 issues an instruction to the industrial vehicle 1B to automatedly perform the transporting process for transporting the pallet PT and the cargo W at the transition position E4. A timing for performing the transporting process subsequently to the unloading process may be based on the industrial vehicle 1A reporting to the server 60 that unloading has been completed. The determination unit 61 may determine that the industrial vehicle 1A, which performs the unloading process, can perform the subsequent unloading process, which is performed subsequently to the transporting process, when the industrial vehicle 1B (e.g., AMR) as the target object reaches the transition position E4. At this time, the instruction unit 62 causes the industrial vehicle 1A to operate automatedly by issuing an instruction to perform the unloading process in which the industrial vehicle 1A unloads the pallet PT and cargo W from the transport vehicle 20 and hands over the pallet PT and the cargo W to the industrial vehicle 1B such as an AMR at the transition position E4.

The determination unit 61 may determine that the subsequent process can be performed based on removal of the target object having been present at the transition position E4 from the transition position E4. When the pallet PT, as the target object, is removed from the transition position E4, the determination unit 61 determines that the industrial vehicle 1A, which performs the unloading process, can perform the subsequent unloading process after the transporting process. When an obstacle, as the target object, is removed from the transition position E4, the determination unit 61 determines that the industrial vehicle 1A can perform the subsequent unloading process after the transporting process. At this time, the instruction unit 62 issues an instruction to the industrial vehicle 1A to automatedly perform the subsequent unloading process for unloading the next pallet PT and the next cargo W from the transport vehicle 20.

The determination unit 61 may determine whether or not the target object is present at the transition position E4 by analyzing the image information and the distance information from the monitoring units 40, 80. In this case, the determination unit 61 may store the position information of the transition position E4 and the like. However, if the monitoring units 40, 80 themselves each include a calculation unit, the monitoring units 40, 80 can determine whether the target object is the pallet PT or an obstacle, and determine the presence or absence of the pallet PT or the obstacle. In this case, the monitoring units 40, 80 may store the position information of the transition position E4 and the like. The monitoring units 40, 80 may generate and transmit determination information, indicating a detail of the target object and whether or not the target object is present, to the control units 50, 30. In this case, the determination unit 61 of the server 60 can make a determination by only referring to the determination information, so that calculation load may be reduced. In addition, when the determination of whether or not the subsequent process can be performed is made by monitoring the transition position E4 by the monitoring units 40, 80, only the determination information, instead of the image information and the distance information, is transmitted to the control units 50, 30 (and hence the server 60). As a result, communication load may be reduced.

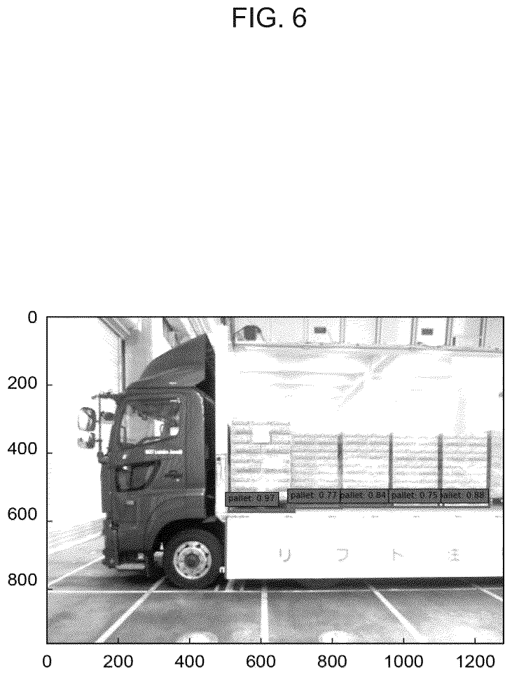

For example, as shown in FIG. 6, the determination unit 61 determines the number of pallets on the loading platform 22 from image data of the loading platform 22 sent from the monitoring unit 40 by a known technique using trained artificial intelligence. The instruction unit 62 transmits the number of the pallets determined by the determination unit 61 to the industrial vehicle 1. This allows the industrial vehicle 1, which performs the automated operation, to determine an operation amount for unloading. Furthermore, if the pallets PT are stacked vertically, the determination unit 61 may determine whether an upper pallet PT or a lower pallet PT is to be unloaded. In addition, by using a technique for determining the pallet PT by artificial intelligence, the determination unit 61 may determine the presence or absence of a person, the presence or absence of the transport vehicle 20, the position of the transport vehicle 20, the height of the loading platform, and the like, based on the image data.

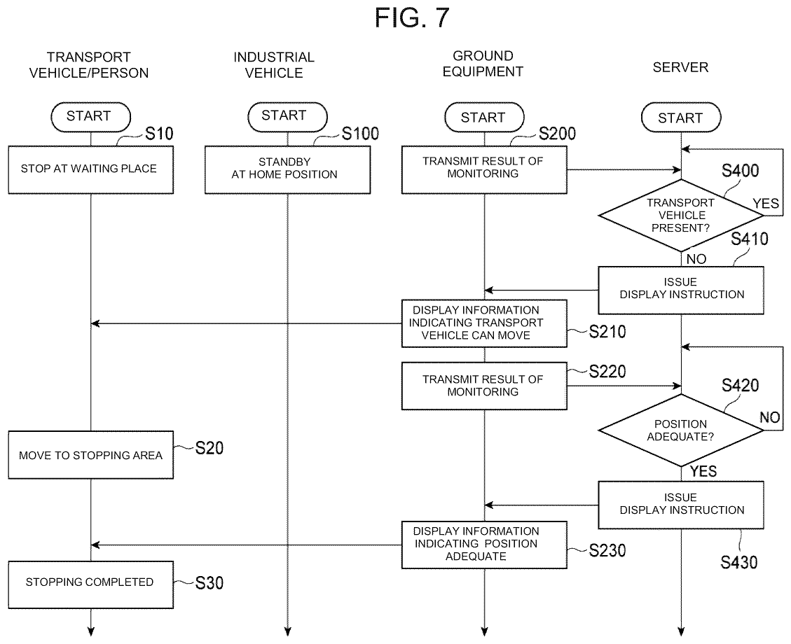

Next, an example of processing executed by the cargo handling system 100 will be described with reference to FIGS. 7 to 16. In the flowchart, operations of “TRUCK (transport vehicle 20)/PERSON,” “INDUSTRIAL VEHICLE,” “GROUND EQUIPMENT,” and “SERVER” are listed in parallel. Firstly, details of processing when the cargos W are loaded and unloaded from the transport vehicle 20 by the automated operation of the industrial vehicle 1 (industrial vehicle 1A in FIG. 2) will be described with reference to FIGS. 7 to 11.

At a start of processing in FIG. 7, the transport vehicle 20 stops at the waiting place E2 (step S10). The industrial vehicle 1 is on standby at the home position E3 (step S100). The monitoring unit 40 of the ground equipment 70 transmits a result of monitoring to the server 60 (step S200). The determination unit 61 of the server 60 determines whether or not the transport vehicle 20 is present in the stopping area E1 (step S400). When the determination unit 61 determines that the transport vehicle 20 is present, the determination unit 61 performs step S400 again. When the determination unit 61 determines that the transport vehicle 20 is not present, the instruction unit 62 issues a display instruction to the display unit 43 of the ground equipment 70 (step S410). The display unit 43 displays information for a driver of the transport vehicle 20, indicating that the transport vehicle 20 can move to the stopping area E1 (step S210). When the determination unit 61 determines in step S400 that the transport vehicle 20 is in the stopping area E1, the display unit 43 may display information indicating that the transport vehicle 20 cannot move to the stopping area E1. The transport vehicle 20 moves to the stopping area E1 at any timing after the information is displayed (step S20).

The monitoring unit 40 transmits the monitoring result to the server 60 (step S220). The determination unit 61 determines whether the position of the transport vehicle 20 in the stopping area E1 is adequate (step S420). When the determination unit 61 determines that the position of the transport vehicle 20 is not adequate, the determination unit 61 performs step S420 again. When the determination unit 61 determines that the position of the transport vehicle 20 is adequate, the instruction unit 62 issues a display instruction to the display unit 43 (step S430). The display unit 43 displays information for the driver of the transport vehicle 20, indicating that the position of the transport vehicle 20 in the stopping area E1 is adequate (step S230). When the determination unit 61 determines in step S420 that the position of the transport vehicle 20 is not adequate, the display unit 43 may display information, indicating that the position of the transport vehicle 20 is not adequate. After the information indicating that the position of the transport vehicle 20 in the stopping area E1 is adequate is displayed, stopping of the transport vehicle 20 is completed (step S30).

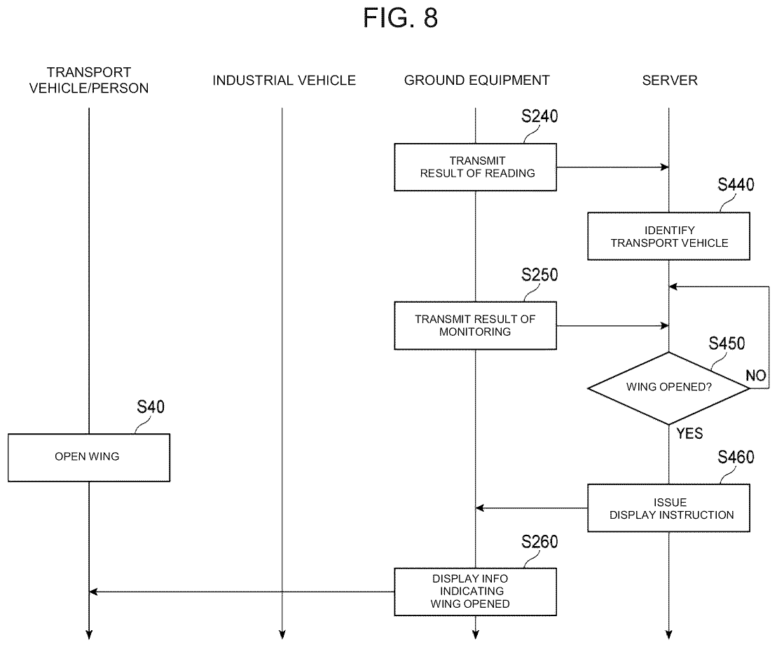

As shown in FIG. 8, the monitoring unit 40 reads the identification information of the identification information providing unit 27 of the transport vehicle 20, and transmits a result of reading to the server 60 (step S240). The determination unit 61 identifies the transport vehicle 20 based on the result of reading (step S440). The transport vehicle 20 opens the wings 26 at any timing after the transport vehicle 20 is stopped (step S40). The monitoring unit 40 transmits the result of monitoring to the server 60 (step S250). The determination unit 61 determines whether or not the wings 26 of the transport vehicle 20 are opened (step S450). When the determination unit 61 determines that the wings 26 are closed, the determination unit 61 performs step S450 again. When the determination unit 61 determines that the wings 26 are opened, the instruction unit 62 issues a display instruction to the display unit 43 of the ground equipment 70 (step S460). The display unit 43 displays information for the driver of the transport vehicle 20, indicating that the wings 26 are opened (step S260). If the determination unit 61 determines in step S450 that the wings 26 are closed, the display unit 43 may display information, indicating that the wings 26 are closed.

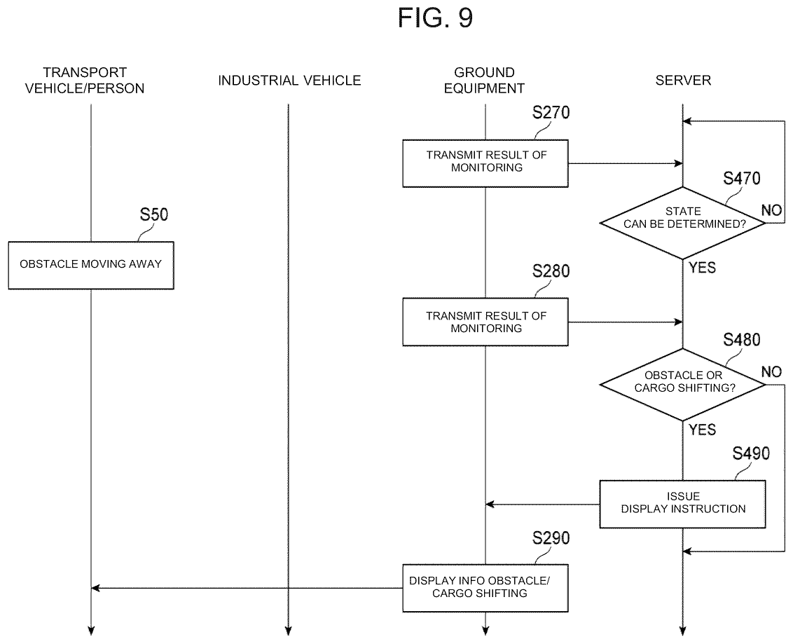

As shown in FIG. 9, the monitoring unit 40 transmits a result of monitoring (step S270). The determination unit 61 makes a determination on various types of conditions relating to the determination of the state of the transport vehicle 20, and on whether or not the state of the transport vehicle 20 can be determined (step S470). An obstacle such as a person may move away from the surrounding area of the transport vehicle 20 at any time after the wings 26 are opened (step S50). When the determination unit 61 determines that the state of the transport vehicle 20 cannot be determined, the determination unit 61 repeats step S470 until the state of the transport vehicle 20 can determined. The monitoring unit 40 transmits a result of monitoring to the server 60 (step S280). The determination unit 61 determines whether or not an obstacle is present in the surrounding area of the transport vehicle 20 and whether or not there is a possibility of cargo shifting (step S480). When the determination unit 61 determines that an obstacle is present or there is a possibility of cargo shifting, the instruction unit 62 issues a display instruction to the display unit 43 of the ground equipment 70 (step S490). The display unit 43 displays information for the driver of the transport vehicle 20, indicating that an obstacle is present or there is a possibility of cargo shifting (step S290). After the display in step S290, waiting may be performed until the obstacle moves away and there is no longer possibility of cargo shifting by performing step S480 again. It is noted that step S490 is omitted when the determination unit 61 determines in step S480 that an obstacle is not present and there is no possibility of cargo shifting.

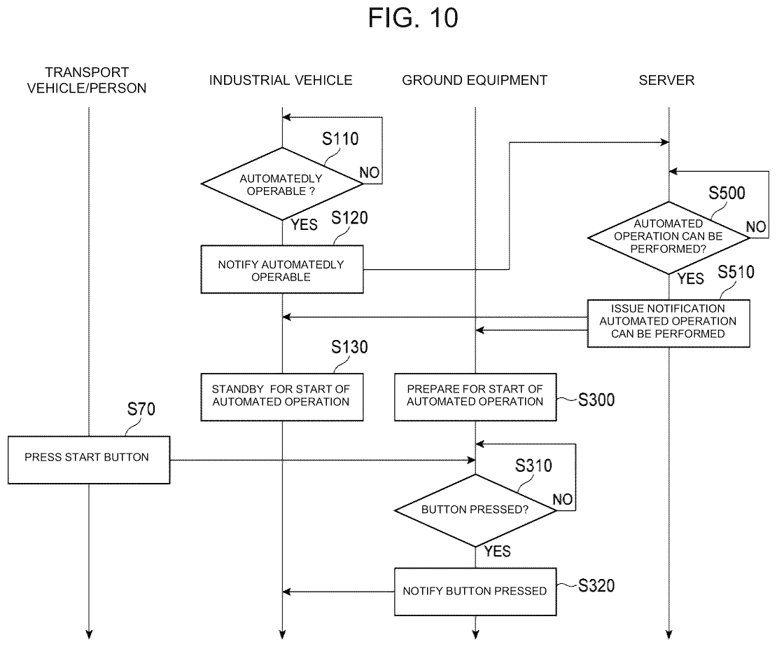

As shown in FIG. 10, the industrial vehicle 1 determines whether or not the industrial vehicle 1 itself is in an automatedly operable state in which the industrial vehicle 1 can perform the automated operation (step S110). When the industrial vehicle 1 is not in the automatedly operable state, step S110 is performed again. When the industrial vehicle 1 is in the automatedly operable state, the industrial vehicle 1 notifies the server 60 as such (step S120). Meanwhile, the determination unit 61 determines whether or not the industrial vehicle 1 can perform the automated operation (step S500). When the determination unit 61 determines that the industrial vehicle 1 cannot perform the automated operation, the determination unit 61 performs step S500 again. After receiving notification of step S120, the determination unit 61 determines that the industrial vehicle 1 can perform the automated operation in step S500. At this time, the instruction unit 62 issue notification indicating that the automated operation can be performed to the industrial vehicle 1 and the ground equipment 70 (step S510). In addition, the instruction unit 62 transmits instruction data necessary for the automated operation to the industrial vehicle 1 in step S510. After receiving the notification, the industrial vehicle 1 becomes in a standby state for the automated operation (step S130). The ground equipment 70 prepares for a start of the automated operation by displaying a button “Start automated operation” on the terminal 44 and starting to accept pressing of the button (step S300). The operator presses the button at any time after this processing (step S70). The ground equipment 70 determines whether or not the button has been pressed (step S310). When the ground equipment 70 determines that the button has not been pressed, the ground equipment 70 performs step S310 again. When the ground equipment 70 determines that the button has been pressed, the ground equipment 70 notifies the industrial vehicle 1 that the button has been pressed (step S320).

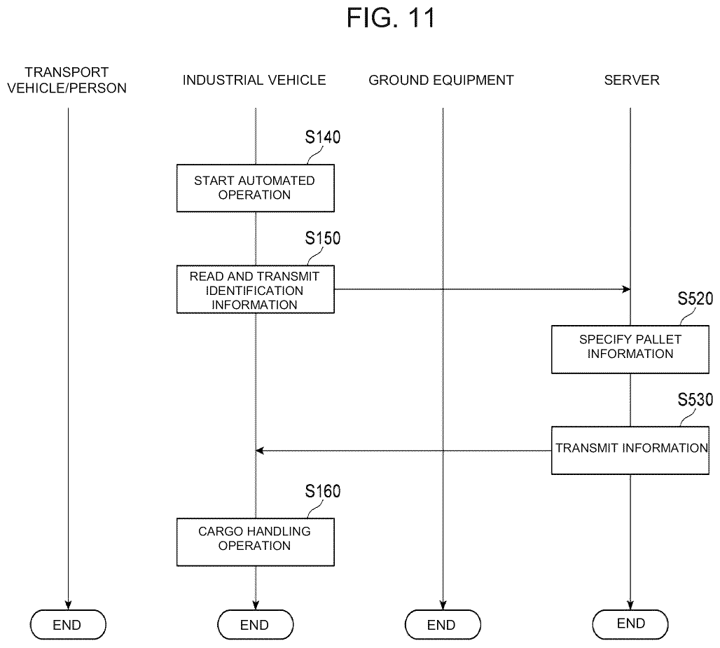

As shown in FIG. 11, the industrial vehicle 1 starts the automated operation based on the instruction data received in step S510 (step S140). The industrial vehicle 1 reads the identification information from the identification information providing unit 28 provided in the pallet PT, and transmits the identification information to the server 60 (step S150). The determination unit 61 specifies pallet information such as a shipper, a type of cargos, a weight of cargos, a destination, and sizes of the pallet holes based on the identification information (step S520). The instruction unit 62 determines unloading location and the distance between the forks, and transmits the information thereof to the industrial vehicle 1 (step S530). The industrial vehicle 1 performs the cargo handling operation based on the information received in step S530 (step S160). Accordingly, the processing shown in FIGS. 7 to 11 ends.

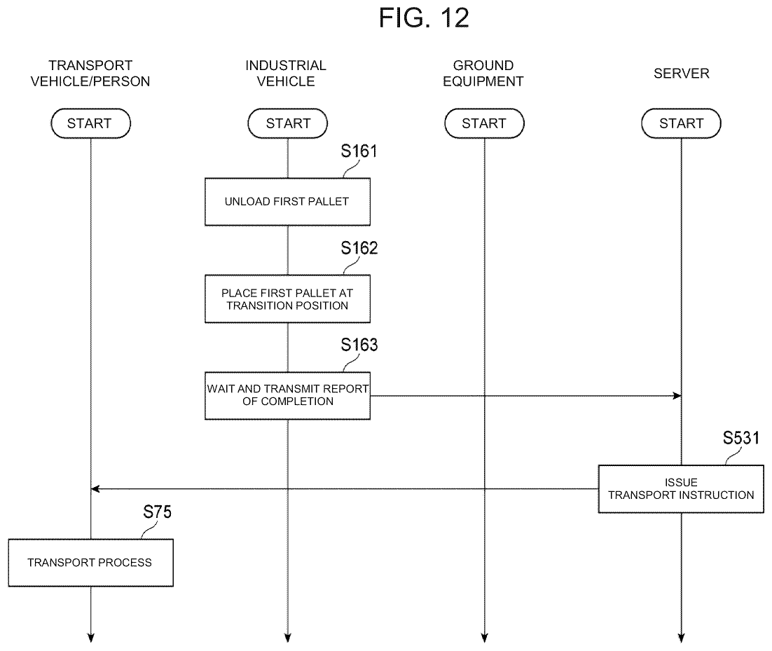

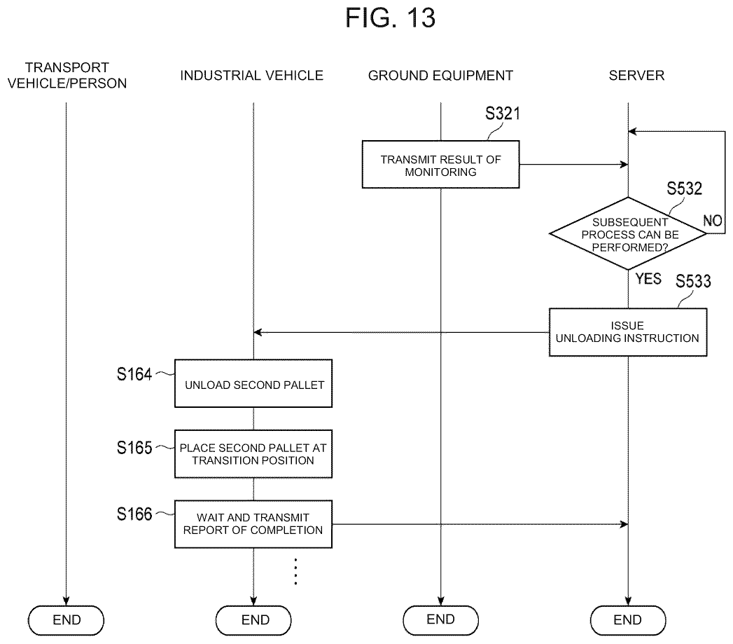

Next, processing when the industrial vehicle 1 unloads the pallet PT from the transport vehicle 20 will be described with reference to FIGS. 12 and 13. As illustrated in FIG. 12, the industrial vehicle 1(1A) unloads the first pallet PT from the transport vehicle 20 (step S161). Then, the industrial vehicle 1(1A) places the pallet PT at the transition position E4 (step S162). After placing the pallet PT, the industrial vehicle 1(1A) waits until the next unloading process and transmits a report of completion of the unloading process to the server 60 (step S163).

When the server 60 receives the report of completion of the unloading process, the server 60 issues an instruction to another industrial vehicle 1(1B) (another forklift truck or AMR), which performs the transporting process, to perform the transporting process (step S531). Another industrial vehicle 1(1B) performs the transporting process in which the pallet PT is transported from the transition position E4 to another location (step S75).

As shown in FIG. 13, the monitoring unit 40 of the ground equipment 70 transmits a result of monitoring to the server 60 (step S321). The determination unit 61 of the server 60 determines whether or not the subsequent unloading process can be performed by determining whether or not the pallet PT is present at the transition position E4 (step S532). When the pallet PT is present at the transition position E4, the server 60 determines that the transporting process has not been performed and the subsequent unloading process cannot be performed. When it is determined that the subsequent unloading process cannot be performed in this way, the determination unit 61 performs step S532 again. On the other hand, when the pallet PT is removed from the transition position E4, the server 60 determines that the transporting process has been performed and the subsequent unloading process can be performed. In this way, when it is determined that the subsequent unloading process can be performed, the instruction unit 62 issues an instruction to the industrial vehicle 1(1A) to perform the unloading process (step S533).

The industrial vehicle 1(1A) unloads the second pallet PT from the transport vehicle 20 (step S164). Then, the industrial vehicle 1 places the pallet PT at the transition position E4 (step S165). After placing the pallet PT, the industrial vehicle 1(1A) waits until the subsequent unloading process and transmits a report of completion of the second unloading process to the server 60 (step S166). Thereafter, the industrial vehicle 1(1A) unloads the pallets PT of the transport vehicle 20 one by one by repeating the same processes. Accordingly, the processing shown in FIGS. 12 and 13 ends.

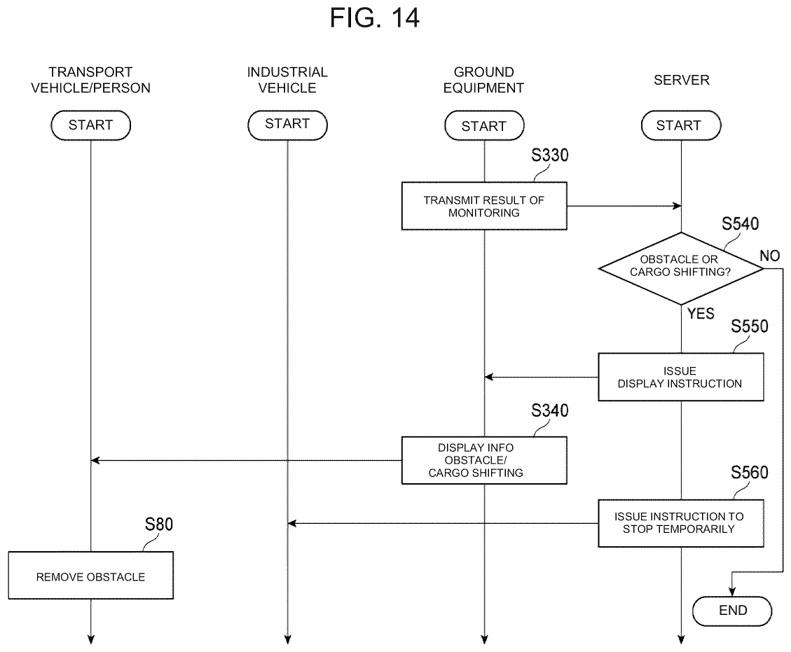

The following will describe processing to temporarily stop the automated operation of the industrial vehicle 1 during the automated operation when an obstacle enters the surrounding area of the transport vehicle 20 and when there is a possibility of cargo shifting with reference to FIGS. 14 to 16. As shown in FIG. 14, the monitoring unit 40 transmits a result of monitoring to the server 60 (step S330). The determination unit 61 determines whether or not an obstacle is present in the surrounding area of the transport vehicle 20 and whether or not there is a possibility of cargo shifting (step S540). When the determination unit 61 determines that no obstacle is present and that there is no possibility of the cargo shifting, the processing shown in FIGS. 14 to 16 ends, and step S330 is performed again. If the determination unit 61 determines that an obstacle is present or there is a possibility of cargo shifting, the instruction unit 62 issues a display instruction to the display unit 43 of the ground equipment 70 (step S550). The display unit 43 displays information for an operator, indicating that an obstacle is present or there is a possibility of cargo shifting (step S340). Furthermore, the instruction unit 62 issues an instruction to the industrial vehicle 1 to stop temporarily (step S560). At any time during this period, the operator removes the obstacle (step S80).

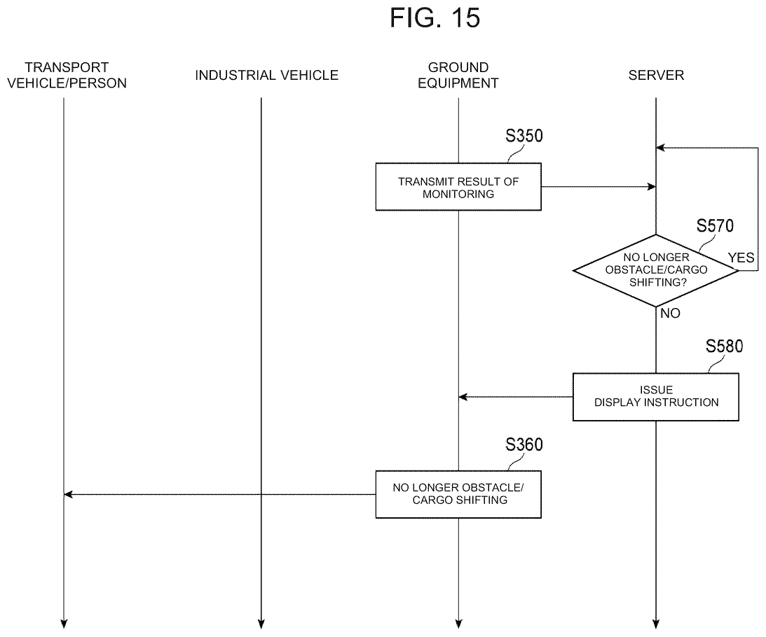

As shown in FIG. 15, the monitoring unit 40 transmits a result of monitoring to the server 60 (step S330). The determination unit 61 determines whether or not an obstacle is no longer present in the surrounding area of the transport vehicle 20 and there is no longer any possibility of the cargo shifting (step S570). When the determination unit 61 determines that an obstacle is present and that there is a possibility of the cargo shifting, the determination unit 61 performs step S570 again. When the determination unit 61 determines that an obstacle is no longer present and there is no longer any possibility of the cargo shifting, the instruction unit 62 issues a display instruction to the display unit 43 of the ground equipment 70 (step S580). The display unit 43 displays information for the operator, indicating that an obstacle is no longer present and there is no longer any possibility of the cargo shifting (step S360).

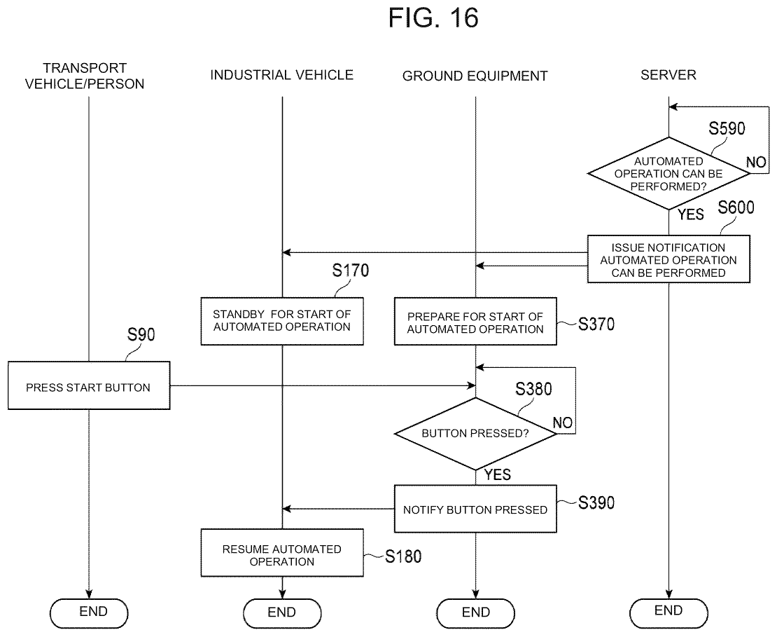

As shown in FIG. 16, the determination unit 61 determines whether or not the industrial vehicle 1 can perform the automated operation (step S590). When the determination unit 61 determines that the industrial vehicle 1 cannot perform the automated operation, the determination unit 61 performs step S590 again. When the determination unit 61 determines that the industrial vehicle 1 can perform the automated operation, the instruction unit 62 issue notification indicating that the automated operation can be performed to the industrial vehicle 1 and the ground equipment 70 (step S600). In addition, the instruction unit 62 transmits instruction data necessary for the automated operation to the industrial vehicle 1 in step S600. After receiving the notification, the industrial vehicle 1 becomes in a standby state for the automated operation (step S170). The ground equipment 70 prepares for a start of the automated operation by displaying a button “Start automated operation” on the terminal 44 and starting to accept pressing of the button (step S370). The operator presses the button at any timing after this processing (step S90). The ground equipment 70 determines whether or not the button has been pressed (step S380). When the ground equipment 70 determines that the button has not been pressed, the ground equipment 70 performs step S380 again. When the ground equipment 70 determines that the button has been pressed, the ground equipment 70 notifies the industrial vehicle 1 that the button has been pressed (step S390). The industrial vehicle 1 resumes the automated operation based on the instruction data received in step S600 (step S180). Accordingly, the processing shown in FIGS. 14 to 16 ends.

Next, the operation and effects of the cargo handling system 100 according to the present embodiment will be described.

The cargo handling system 100 includes the monitoring units 40, 80 that monitor the state at the transition position E4 where one process transitions to another process in the cargo handling operation. The monitoring units 40, 80 can monitor the state at the transition position E4 while one process transitions to another process, such as a state of handing over the cargo W at a handover place. From the state at the transition position E4, for example, whether or not there is the cargo W or there is an obstacle can be determined. As a result, whether it is in a state in which the subsequent process can be performed can be determined. In addition, the cargo handling system 100 includes the determination unit 61 that determines whether or not the subsequent process can be performed based on the information acquired by the monitoring units 40, 80. The determination unit 61 can automatedly determine whether or not the subsequent process can be performed by grasping the state at the transition position E4 without depending on the determination by an operator. As a result, manpower-saving in the cargo handling system 100 may be achieved. This allows the industrial vehicles 1 to operate automatedly smoothly.

The determination unit 61 may determine that the subsequent process can be performed based on removal of the target object having been present from the transition position E4. Removing the target object from the transition position E4 allows the process of placing the next target object at the transition position E4 to be performed. As a result, the determination unit 61 can easily make a determination based on removal of the target object from the transition position E4.

The determination unit 61 may determine that the subsequent process can be performed based on arrival of the target object at the transition position E4. Arrival of the target object at the transition position E4 allows the process of transporting the target object at the transition position E4 to be performed. As a result, the determination unit 61 can easily make a determination based on arrival of the target object at the transition position E4.

The target object may be the pallet PT. This allows the monitoring units 40, 80 to easily grasp the state at the transition position E4 by monitoring the presence or absence of the pallet PT at the transition position E4.

The monitoring units 40, 80 may include image acquisition units 41, 81, respectively, that acquire images. As a result, various states of the transition position E4 may be grasped by analyzing the acquired images. For example, the presence or absence of the pallet PT can be detected with high accuracy.

The monitoring units 80 may be provided in the industrial vehicle 1. In this case, the monitoring units 80 can grasp the state at the transition position E4 in the workflow of the operation of the industrial vehicles 1 performing cargo handling.

The monitoring units 40 may be provided at a position different from the industrial vehicle 1 in the work site. In this case, the monitoring units 40 can monitor the state at the transition position E4 from a location in the work site where monitoring is performed easily regardless of the operation of the industrial vehicle 1. This makes it possible to omit the monitoring unit 80 of the industrial vehicle 1 and perform monitoring only with the monitoring unit 40 of the equipment. In this case, a need for high-performance monitoring instrument in each of industrial vehicles 1 can be suppressed.

The present disclosure is not limited to the above-described embodiment.

For example, the configuration of the cargo handling system including the work site illustrated in FIGS. 2 and 3 is an example, and may be changed as appropriate. The flowcharts shown in FIGS. 7 to 16 are merely an example of processing, and may be changed as appropriate.

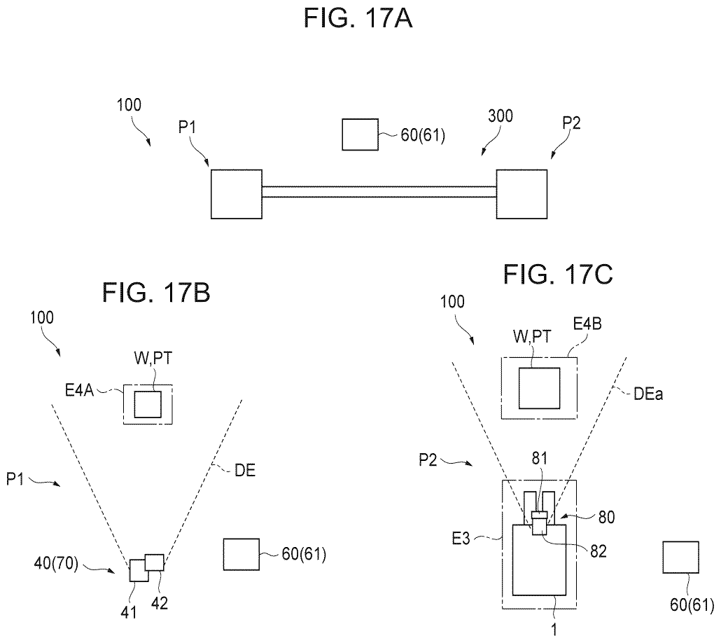

For example, the cargo handling system 100 may be applied to a work site illustrated in FIGS. 17A to 17C. A work site 300 illustrated in FIG. 17A includes a receiving place P1 where the cargo W is received, and a dispatching place P2 where the cargo W is dispatched. FIG. 17B is a schematic view illustrating the receiving place P1. FIG. 17C is a schematic view illustrating the dispatching place P2.

As illustrated in FIG. 17B, the receiving place P1 is equipped with a monitoring unit 40 of the ground equipment. The monitoring unit 40 monitors a transition position E4A where the cargo W to be received is placed. The pallet PT and the cargo W are placed at the transition position E4A using a lift or the like. The pallet PT and the cargo W placed at the transition position E4A are transported by the industrial vehicle 1 in the dispatching place P2. As illustrated in FIG. 17C, the dispatching place P2 has a home position E3 for the industrial vehicle 1. The monitoring unit 80 of the industrial vehicle 1 monitors a transition position E4B where the cargo W to be dispatched is placed. The industrial vehicle 1 places the pallet PT and the cargo W received in the receiving place P1 at the transition position E4B. The pallet PT and the cargo W placed at the transition position E4B are transported to a truck or the like by another industrial vehicle.

In this work site 300, firstly, a process in which the pallet PT and the cargo W to be received are placed at the transition position E4A in the receiving place P1 is performed. At this time, the determination unit 61 determines, based on the information from the monitoring unit 40, that the subsequent transporting process can be performed in the receiving place P1. On the other hand, if the pallet PT and the cargo W are present at the transition position E4B in the dispatching place P2, the next pallet PT and the next cargo W cannot be placed at the transition position E4B. In other words, the subsequent transporting process cannot be performed. Therefore, based on the information from the monitoring unit 80, the determination unit 61 determines that the subsequent transporting process can be performed when the previous pallet PT and the previous cargo W are no longer present at the transition position E4B in the dispatching place P2.

When it is determined that the subsequent transporting process can be performed both in the receiving place P1 and in the dispatching place P2, the industrial vehicle 1 moves from the dispatching place P2 to the receiving place P1. Then, the industrial vehicle 1 receives the pallet PT and the cargo W at the transition position E4A in the receiving place P1, returns to the dispatching place P2, and places them at the transition position E4B. Meanwhile, in the receiving place P1, the determination unit 61 determines that the process of placing the next pallet PT and the next cargo W at the transition position E4A can be performed based on removal of the pallet PT and the cargo W from the transition position E4A. By repeating these processes, the cargo handling operation of the industrial vehicle 1 can be automatedly continued at the work site 300 without checking by an on-site operator.

The idea of the present disclosure is described as following [Mode 1] to [Mode 7].

[mode 1]

An industrial vehicle performs cargo handling operation, the cargo handling system comprising:
the industrial vehicle
a work site where industrial vehicles perform cargo handling operation;
a monitoring unit configured to monitor a state at a transition position where one process transitions to another process during the cargo handling operation;
a determination unit configured to determine whether or not a subsequent process is performable based on information acquired by the monitoring unit.
   [mode 2]

The cargo handling system according to [Mode 1], wherein the determination unit determines that the subsequent process is performable based on removal of a target object having been present from the transition position.

### [mode 3]

The cargo handling system according to [Mode 1] or [Mode 2], wherein the determination unit determines that the subsequent process is performable based on arrival of a target object at the transition position.

[mode 4]

The cargo handling system according to [Mode 2] or [Mode 3], wherein the target object is a pallet.

[mode 5]

The cargo handling system according to any one of [Mode 1] to [Mode 4], wherein the monitoring unit includes an image acquisition unit that acquires an image.

[mode 6]

The cargo handling system according to any one of [Mode 1] to [Mode 5], wherein the monitoring unit is provided in the industrial vehicle.

[mode 7]

The cargo handling system according to any one of [Mode 1] to [Mode 6], wherein the monitoring unit is provided at a position in the work site different from the industrial vehicle.

1. A cargo handling system in which an industrial vehicle performs cargo handling operation, the cargo handling system comprising:
the industrial vehicle;
a work site where the industrial vehicle performs a cargo handling operation;
a camera provided at a position in the work site different from the industrial vehicle and configured to monitor a state of a transition position at which a target object transitions from one process to a subsequent process in the cargo handling operation; and
a processor configured to:
determine whether the subsequent process is performable based on information acquired by the camera, and
based on the subsequent process being performable, transmit an instruction to the industrial vehicle to perform the subsequent process.

2. The cargo handling system according to claim 1, wherein the processor is configured to determine that the subsequent process is performable based on removal of the target object having been present from the transition position.

3. The cargo handling system according to claim 1, wherein the processor is configured to determine that the subsequent process is performable based on arrival of the target object at the transition position.

4. The cargo handling system according to claim 2, wherein the target object is a pallet.

5. (canceled)

6. (canceled)

7. (canceled)

8. The cargo handling system according to claim 1, wherein the work site comprises a plurality of areas that are separately arranged from each other, the plurality of areas comprising the transition position and a stopping position,
wherein the subsequent process includes moving the target object between the transition position and the stopping position, and
wherein the processor is configured to:
determine whether the subsequent process is performable based on information acquired by the camera about the transition position,
based on the subsequent process being performable, transmit an instruction to the industrial vehicle to perform the subsequent process including moving the target object between the transition position and the stopping position.

9. The cargo handling system according to claim 8, wherein the plurality of areas further comprise a third area, and the one operation includes moving the target object between the third area and the transition position,
wherein the cargo handling system further comprises a second industrial vehicle configured to perform the one operation, and
wherein the processor is configured to determine that the subsequent process is performable based on removal of the target object from the transition position by the industrial vehicle or the second industrial vehicle.

10. A cargo handling system in which an industrial vehicle performs cargo handling operation, the cargo handling system comprising:
the industrial vehicle;
a work site where the industrial vehicle performs a cargo handling operation, the work site comprising a stopping position and a transition position separate from the stopping position, the transition position being an area at which a target object transitions from one process to a subsequent process in the cargo handling operation;
a camera configured to monitor a state of the transition position; and
a processor configured to:
determine whether the subsequent process is performable based on information acquired by the camera about the state of the transition position, and
based on the subsequent process being performable, transmit an instruction to the industrial vehicle to perform the subsequent process.

11. The cargo handling system according to claim 10, wherein the processor is configured to determine that the subsequent process is performable based on removal of the target object from the transition position.
